(19) United States
(12) Patent Application Publication
(10) Pub. No.: US 2017/0053291 A1
(43) Pub. Date: Feb. 23, 2017

(54) OPTIMAL TIME SCALE AND DATA VOLUME FOR REAL-TIME FRAUD ANALYTICS

(71) Applicant: International Business Machines Corporation, Armonk, NY (US)

(72) Inventors: Rajiv CHODHARI, Plainsboro, NJ (US); Subhendu DAS, Chapel Hill, NC (US); Chitra DORAI, Chappaqua, NY (US); Ying LI, Mohegan Lake, NY (US)

(21) Appl. No.: 14/828,479

(22) Filed: Aug. 17, 2015

(51) Int. Cl. G06Q 30/00

(52) U.S. Cl. CPC G06Q 30/0185

(57) ABSTRACT

In analyzing real-time order data, a surveillance system obtains historical orders data in a historical order stream labeled for a given rule, and for the given rule, determines optimal time and optimal data volume using a distribution model for the historical orders data. The surveillance system obtains real-time orders data from a real-time order stream within the optimal time or optimal data volume, determines that at least one real-time orders data violates the given rule, and validates that the real-time orders data indicates fraudulent activity. The surveillance system determines that the real-time orders data does not conform to the distribution model for the given rule, and in response, updates the distribution model using the real-time orders data, and updates the determination of the optimal time and optimal data volume using the updated distribution model and associating the updated optimal time and the updated optimal data volume with the given rule.

### BACKGROUND

Surveillance systems exist for analyzing data and identifying patterns that violate certain rules. When used in financial markets to monitor trade orders, the purpose of these surveillance systems is to identify illegal and abusive trading practices in the market. However, most of the surveillance systems work offline, i.e., after the monitored activities have completed and initial notifications have been sent to the parties involved. The surveillance system performs offline analyses of the activity data to find certain patterns. Once these patterns are detected, the details of the activities are collected, and an alert is generated for the system administrator to analyze and confirm or deny the activities as fraudulent or illegal activity. The system administrator may then take further appropriate action based on the analysis and confirmation/denial. Some surveillance systems can be used for real-time fraud detection, however, they are rudimentary and use fixed rules to detect anomalies in data patterns. Typically rules based systems are rigid and can only detect simple, easy to understand patterns.

### SUMMARY

According to one embodiment of the present invention, in analyzing real-time order data, a surveillance system obtains historical orders data in a historical order stream labeled for a given rule, and for the given rule, determines an optimal time and an optimal data volume using a distribution model for the historical orders data. the surveillance system further obtains real-time orders data from a real-time order stream within the optimal time or the optimal data volume, determines that at least one real-time orders data violates the given rule, and validates that the real-time orders data indicates fraudulent activity. The surveillance system further determines that the real-time orders data does not conform to the distribution model for the given rule, and in response, incrementally updates the distribution model using the real-time orders data, and subsequently updates the determination of the optimal time and the optimal data volume using the updated distribution model for the real-time orders data and associating the updated optimal time and the updated optimal data volume with the given rule.

System and computer program products corresponding to the above-summarized methods are also described and claimed herein.

### BRIEF DESCRIPTION OF THE DRAWINGS

FIG. 1 illustrates a surveillance system according to embodiments of the present invention.

FIG. 2 illustrates a method for analyzing real-time order data according to embodiments of the present invention.

FIG. 3 illustrates a method for determining an optimal time and an optimal data volume according to embodiments of the present invention.

FIG. 4 illustrates an example ROC, where the x-axis is the rate of false positives, and the y-axis is the rate of true positives.

FIG. 5 illustrates a computer system according to embodiments of the present invention.

### DETAILED DESCRIPTION

Embodiments of the present invention enhance distribution models, allowing a surveillance system to learn over time the optimal sampling frequency of data for streaming data as well as the optimal sampling volume of data. If the time scale or sample volume is too small, this may lead to the detection of a large number of false positives. If the time scale or sample volume is too large, frauds may fail to be detected, leading to potentially large losses. Embodiments of the present invention present near real-time fraud detection with rules that may be changed over time. The optimal time or data volume required for a type of rule or predictive analytics is determined by evaluating historical fraud data.

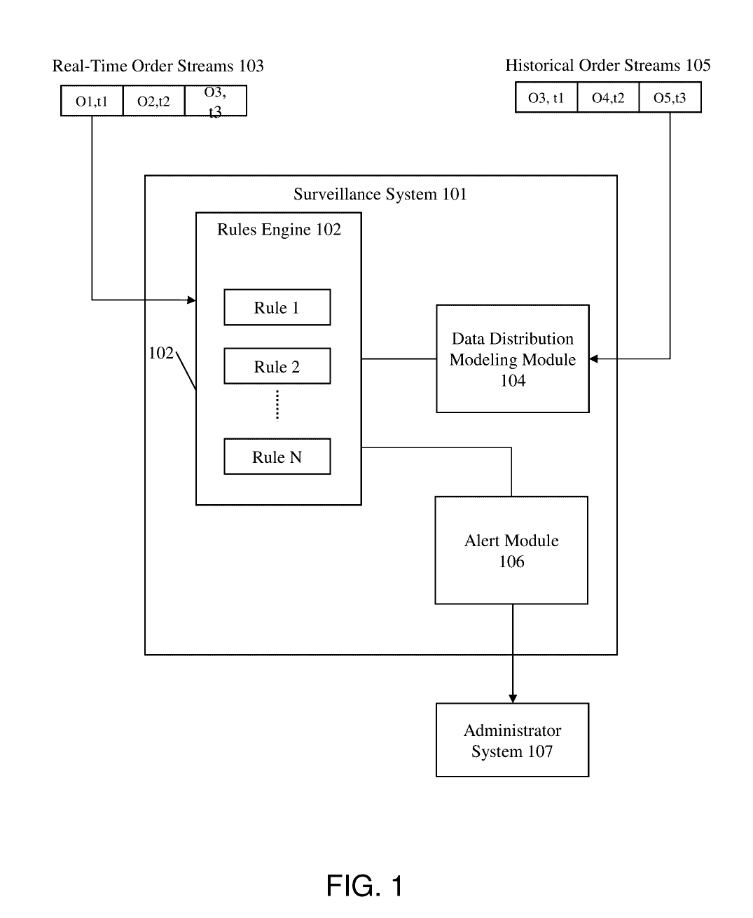

FIG. 1 illustrates a surveillance system according to embodiments of the present invention. The surveillance system 101 includes a rules engine 102, a data distribution modeling module 104, and an alert module 106. A user, typically a system administrator, configures a plurality of rules (Rule 1, Rule 2, . . . , Rule N), where each rule defines order data patterns that may indicate illegal or fraudulent activity. The rules engine 102 sample real-time order streams 103 of trade orders and determines whether one or more trade orders violate one or more of the rules. The modeling module 104 determines an optimal amount of time and an optimal volume of data to be sampled for each rule, using historical order streams 105 with order data labeled for each rule. The alert module 106 sends alerts to an administrator system 107 if and when any of the real-time order trade data is determined to indicate fraudulent activity.

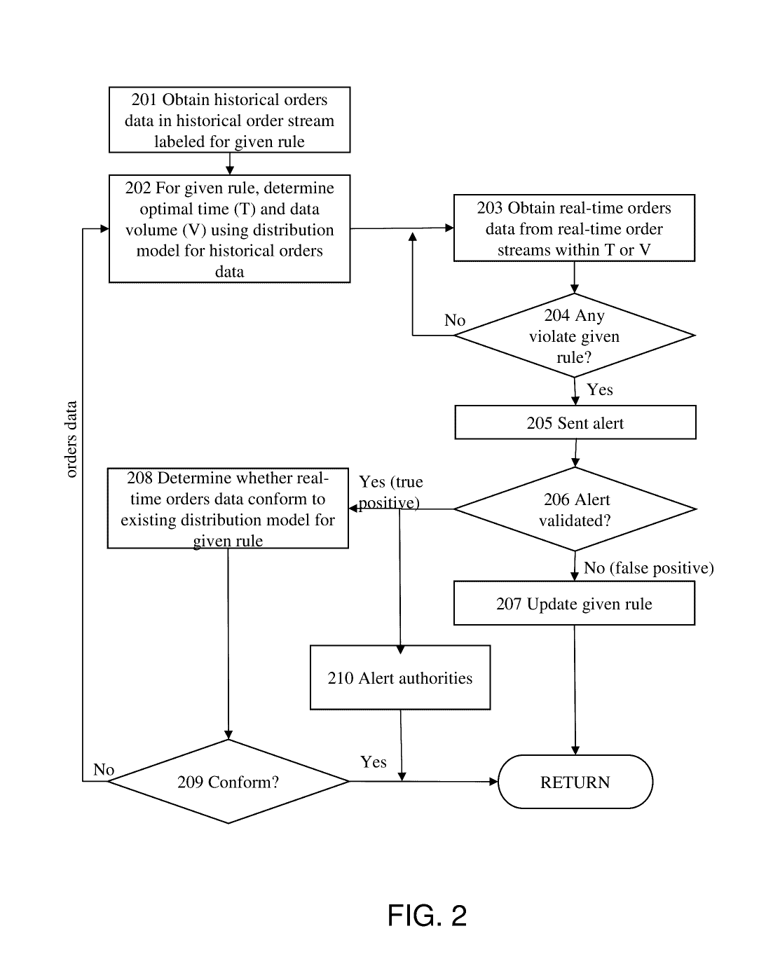

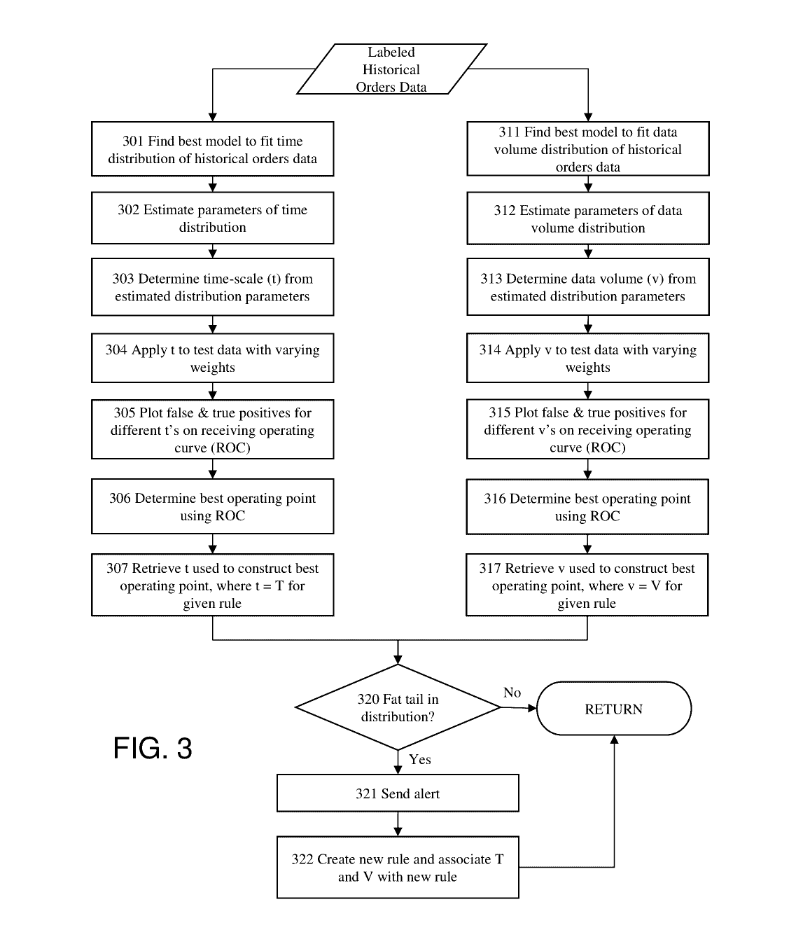

FIG. 2 illustrates a method for analyzing real-time order data according to embodiments of the present invention. Referring to both FIGS. 1 and 2, the modeling module 104 obtains historical orders data in the historical order streams 105 labeled for a given rule (201). For the given rule, the modeling module 104 determines the optimal time (T) and optimal data volume (V) using a distribution model for the historical orders data (202). The determinations of T and V are described further below with reference to FIG. 3. The rules engine 102 obtains real-time orders data from the real-time order streams 103 within the T and/or V associated with the given rule (203). The rules engine 102 obtains real-time orders data until the optimal time (T) is reached, or until the optimal data volume (V) is gathered, or both. For example, assume that T=10 minutes and V=100 orders for Rule 1. If the rules engine 102 samples the order data for 10 minutes and obtains 50 orders, then the T constraint is met, and orders data for the 50 orders is analyzed. If the rules engine 102 obtains 100 orders within 5 minutes, then the V constraint is met, and orders data for the 100 orders is analyzed. The rules engine 102 determines whether any of the real-time orders data violate the given rule (204). If so, then the alert module 106 sends an alert to the administrator system 107 (205). The administrator system 107 attempts to validate the alert as either a false positive (real-time orders data does not indicate actual fraudulent activity) or a true positive (real-time orders data indicates actual fraudulent activity). If the alert is not validated (206), then the given rule may be updated in order to decrease a rate of false positives (207). If the alert is validated (206), then the administrator system 107 notifies the appropriate authorities 210, which can then take further action. The administrator system 107 further determines whether the real-time orders data conform to the existing distribution model for the given rule (208). Here, the modeling module 104 measures how well the existing distribution model fits the real-time orders data, such as by summarizing the discrepancy between the observed values and values expected under the existing distribution model. Any variety of techniques known in the art may be used, including, but not limited to: Kolmogorov-Smirnov test; Cramer-von Mises criterion; Anderson-Darling test; Shapiro-Wilk test; Chi Square test; Akaike information criterion; and Hosmer-Lemeshow test. If the real-time orders data is determined to not conform (209), then the modeling module 104 incrementally updates the distribution model using the real-time orders data obtained in step 203, and subsequently updates its determination of T and V for the given rule (202). The updated T and V are then used in the further analysis of the real-time order streams 103 (203-207). The steps illustrated in FIG. 2 are repeated for one or more of the plurality of rules applied by the surveillance system 101, where a set of real-time orders data may be obtained from the real-time order streams 103 for each given rule. The sets of real-time orders data are then analyzed as described here.

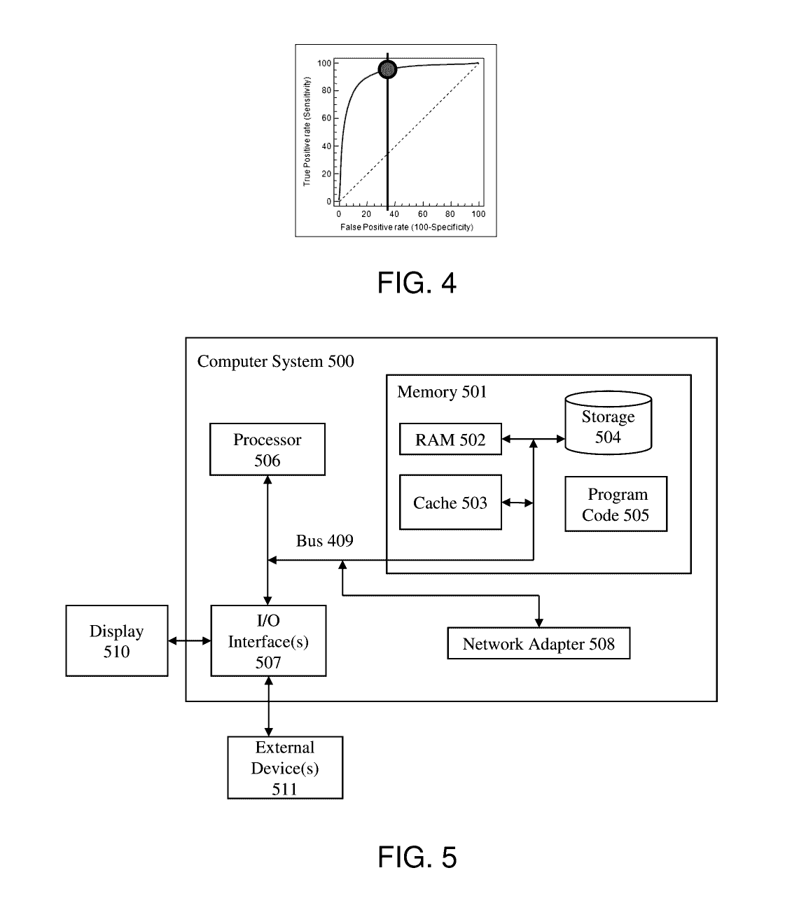

FIG. 3 illustrates a method for determining an optimal time and an optimal data volume according to embodiments of the present invention. Steps 301-307 describe the determination of the optimal time (T), and steps 311-317 describe the determination of the optimal data volume (V). For the labeled historical orders data obtained in step 201, the modeling module 104 finds a best model to fit the time distribution of the historical orders data (301) where x-axis indicates the amount of time needed to detect a rule violation, and y-axis indicates the occurring frequency of each respective violation. The modeling module 104 then estimates one or more parameters of the time distribution (302). In this embodiment, one of several techniques may be used including parametric method and regression method. In the parametric method, the parameters of the distribution are calculated from the data series. Example parametric methods include, but are not limited to, a method of moments, a method of L-moments, and a maximum likelihood method. In the regression method, a transformation of the cumulative distribution function is used so that a linear relation is found between the cumulative probability and the values of the data. The parametric and regression methods are known in the art and will not be further described here. Other techniques may also be used to estimate the parameters. Example parameters of the time distribution includes, but are not limited to, a calculated mean (μ) and standard deviation (a) for a normal distribution. The modeling module 104 then determines a time-scale (t) from the estimated distribution parameters (303). For example, a weighted approach may be used, where t=μ+α*σ, where α is a weight. The modeling module 104 applies t to test data with varying weights (α) (304). The test data may be part of the labeled historical data. For example, the historical data can be partitioned into two portions, one for training (i.e. estimating the distribution model parameters), and one for testing and finding the optimal α. In this embodiment, different t's are calculated by varying the weight (α). Each t is applied to the test data to determine whether a violation of a given rule is detected, and the false and true positives for the different t's are measured and plotted on a receiving operating curve (ROC) (305). FIG. 4 illustrates an example ROC, where the x-axis is the rate of false positives, and the y-axis is the rate of true positives. Using the ROC, the modeling module 104 determines the best operating point (306). The best operating point is the balance of the rate of false positives and true positives that can be tolerated by a business or system. The modeling module 104 retrieves the t used to construct the best operating point, and configures this t as the optimal time (T) for the given rule (307).

For the same labeled historical orders data obtained in step 201, the modeling module 104 finds a best model to fit the data volume distribution of the historical orders data, where x-axis indicates the amount of data volume needed to detect a rule violation, and y-axis indicates the occurring frequency of each respective violation (311). The modeling module 104 then estimates one or more parameters of the data volume distribution (312). In this embodiment, the same techniques described above may be used. The modeling module 104 then determines a data volume (v) from the estimated distribution parameters (313). The same weighted approach described above may be used. The modeling module 104 applies v to test data with varying weights (α) (314), where different v's are calculated by varying the weight (α). Each v is applied to the test data to determine whether a violation of a given rule is detected, and the false and true positives are measured and plotted on a receiving operating curve (ROC) (315). Using the ROC, the modeling module 104 determines the best operating point (316). The modeling module 104 retrieves the v used to construct the best operating point, and configures this V as the optimal data volume (V) for the given rule (317).

The T and V determined as illustrated in FIG. 3 are then used in the analysis of real-time order streams 103 as set forth in FIG. 2. In this embodiment, the modeling module 104 further determines whether a “fat tail” exists in the distribution (320). The distribution contains a fat tail when, over a large period of time, no violations of a given rule is identified. This may occur when the given rule is no longer applicable, such as when trade order patterns change, or when outlier data are not being captured. When a fat tail is detected, the alert module 106 sends an alert to the administrator system 107 (321). The administrator system 107 may respond by creating a new rule and associates the T and V calculated above as the optimal time and optimal data volume with the new rule (322). The new rule may then be applied to the real-time order streams 103 by the rules engine 102 as set forth above.

In the above described manner, embodiments of the present invention are capable of incrementally updating the distribution models “on the fly” by taking the outcome of applying the T and V to real-time orders data and adapting the distribution models to the real-time orders data. The surveillance system 101 is thus adaptive in its ability to update the T and V over time, and in its ability to support new rules and to update existing rules.

The surveillance system 101 and/or the administrator system 107 may include one or more computer systems. FIG. 5 illustrates a computer system according to embodiments of the present invention. The computer system 500 is operationally coupled to a processor or processing units 506, a memory 501, and a bus 509 that couples various system components, including the memory 501 to the processor 506. The bus 509 represents one or more of any of several types of bus structure, including a memory bus or memory controller, a peripheral bus, an accelerated graphics port, and a processor or local bus using any of a variety of bus architectures. The memory 401 may include computer readable media in the form of volatile memory, such as random access memory (RAM) 502 or cache memory 503, or non-volatile storage media 504. The memory 501 may include at least one program product having a set of at least one program code module 505 that are configured to carry out the functions of embodiment of the present invention when executed by the processor 506. The computer system 500 may also communicate with one or more external devices 511, such as a display 510, via I/O interfaces 507. The computer system 500 may communicate with one or more networks via network adapter 508.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention has been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for analyzing real-time order data using optimal time scale and data volume by a surveillance system, comprising:
obtaining historical orders data in a historical order stream labeled for a given rule;
for the given rule, determining an optimal time and an optimal data volume using a distribution model for the historical orders data;
obtaining real-time orders data from a real-time order stream within the optimal time or the optimal data volume;
determining the at least one real-time orders data violates the given rule;
validating the at least one real-time orders data as indicating fraudulent activity;
in response to validating the at least one real-time order as indicating fraudulent activity, determining that the real-time orders data does not conform to the distribution model for the given rule; and
in response to determining that the real-time orders data does not conform to the distribution model for the given rule, updating the distribution model using the real-time orders data, and subsequently updating the determination of the optimal time and the optimal data volume using the updated distribution model for the real-time orders data and associating the updated optimal time and the updated optimal data volume with the given rule.

2. The method of claim 1, further comprising:
failing to validate the at least one real-time orders data as indicating fraudulent activity; and
in response, updating the given rule.

3. The method of claim 1, wherein the determining of the optimal time using the distribution model for the historical orders data comprises:
finding a best model to fit a time distribution of the historical orders data labeled for the given rule;
estimating one or more parameters of the time distribution;
determining a time-scale from the one or more parameters;
applying the time-scale to test data with varying weights to calculate different time-scales;
plotting false positives and true positives for the different time-scales on a curve;
determining a best operating point using the curve; and
retrieving the time-scale used to construct the best operating point and setting the retrieved time-scale as the optimal time for the given rule.

4. The method of claim 1, wherein the determining of the optimal data volume using the distribution model for the historical orders data comprises:
finding a best model to fit a data volume distribution of the historical orders data labeled for the given rule;
estimating one or more parameters of the data volume distribution;
determining a data volume from the one or more parameters;
applying the data volume to test data with varying weights to calculate different data volumes;
plotting false positives and true positives for the different data volumes on a curve;
determining a best operating point using the curve; and
retrieving the data volume used to construct the best operating point and setting the retrieved data volume as the optimal data volume for the given rule.

5. The method of claim 1, further comprising:
determining that the distribution model comprises a fat tail;
in response, creating a new rule and associating the optimal time and the optimal data volume with the new rule.

6. The method of claim 1, wherein the obtaining of the real-time orders data from the real-time order stream within the optimal time or the optimal data volume and the determining that at least one real-time orders data violates the given rule comprise:
obtaining the real-time orders data from the real-time order stream;
determining that the optimal time is met; and
in response, determining that at least one real-time order data obtained within the optimal time violates the given rule.

7. The method of claim 1, wherein the obtaining of the real-time orders data from the real-time order stream within the optimal time or the optimal data volume and the determining that at least one real-time orders data violates the given rule comprise:
obtaining the real-time orders data from the real-time order stream;
determining that the optimal data volume is met; and
in response, determining that at least one real-time order data within the optimal data volume violates the given rule.

8. A computer program product for analyzing real-time order data using optimal time scale and data volume, the computer program product comprising a computer readable storage medium having program instructions embodied therewith, the program instructions executable by a processor to cause the processor to perform a method comprising:
obtaining historical orders data in a historical order stream labeled for a given rule;
for the given rule, determining an optimal time and an optimal data volume using a distribution model for the historical orders data;
obtaining real-time orders data from a real-time order stream within the optimal time or the optimal data volume;
determining the at least one real-time orders data violates the given rule;
validating the at least one real-time orders data as indicating fraudulent activity;
in response to validating the at least one real-time order as indicating fraudulent activity, determining that the real-time orders data does not conform to the distribution model for the given rule; and
in response to determining that the real-time orders data does not conform to the distribution model for the given rule, updating the distribution model using the real-time orders data, and subsequently updating the determination of the optimal time and the optimal data volume using the updated distribution model for the real-time orders data and associating the updated optimal time and the updated optimal data volume with the given rule.

9. The computer program product of claim 8, wherein the method further comprises:
failing to validate the at least one real-time orders data as indicating fraudulent activity; and
in response, updating the given rule.

10. The computer program product of claim 8, wherein the determining of the optimal time using the distribution model for the historical orders data comprises:
finding a best model to fit a time distribution of the historical orders data labeled for the given rule;
estimating one or more parameters of the time distribution;
determining a time-scale from the one or more parameters;
applying the time-scale to test data with varying weights to calculate different time-scales;
plotting false positives and true positives for the different time-scales on a curve;
determining a best operating point using the curve; and
retrieving the time-scale used to construct the best operating point and setting the retrieved time-scale as the optimal time for the given rule.

11. The computer program product of claim 8, wherein the determining of the optimal data volume using the distribution model for the historical orders data comprises:
finding a best model to fit a data volume distribution of the historical orders data labeled for the given rule;
estimating one or more parameters of the data volume distribution;
determining a data volume from the one or more parameters;
applying the data volume to test data with varying weights to calculate different data volumes;
plotting false positives and true positives for the different data volumes on a curve;
determining a best operating point using the curve; and
retrieving the data volume used to construct the best operating point and setting the retrieved data volume as the optimal data volume for the given rule.

12. The computer program product of claim 8, wherein the method further comprises:
determining that the distribution model comprises a fat tail;
in response, creating a new rule and associating the optimal time and the optimal data volume with the new rule.

13. The computer program product of claim 8, wherein the obtaining of the real-time orders data from the real-time order stream within the optimal time or the optimal data volume and the determining that at least one real-time orders data violates the given rule comprise:
obtaining the real-time orders data from the real-time order stream;
determining that the optimal time is met; and
in response, determining that at least one real-time order data obtained within the optimal time violates the given rule.

14. The computer program product of claim 8, wherein the obtaining of the real-time orders data from the real-time order stream within the optimal time or the optimal data volume and the determining that at least one real-time orders data violates the given rule comprise:
obtaining the real-time orders data from the real-time order stream;
determining that the optimal data volume is met; and
in response, determining that at least one real-time order data within the optimal data volume violates the given rule.

15. A surveillance system, comprising
a processor; and
a computer readable storage medium having program instructions embodied therewith, the program instructions executable by a processor to cause the processor to perform a method comprising:
obtaining historical orders data in a historical order stream labeled for a given rule;
for the given rule, determining an optimal time and an optimal data volume using a distribution model for the historical orders data;
obtaining real-time orders data from a real-time order stream within the optimal time or the optimal data volume;
determining the at least one real-time orders data violates the given rule;
validating the at least one real-time orders data as indicating fraudulent activity;
in response to validating the at least one real-time order as indicating fraudulent activity, determining that the real-time orders data does not conform to the distribution model for the given rule; and
in response to determining that the real-time orders data does not conform to the distribution model for the given rule, updating the distribution model using the real-time orders data, and subsequently updating the determination of the optimal time and the optimal data volume using the updated distribution model for the real-time orders data and associating the updated optimal time and the updated optimal data volume with the given rule.

16. The system of claim 15, wherein the determining of the optimal time using the distribution model for the historical orders data comprises:
finding a best model to fit a time distribution of the historical orders data labeled for the given rule;
estimating one or more parameters of the time distribution;
determining a time-scale from the one or more parameters;
applying the time-scale to test data with varying weights to calculate different time-scales;
plotting false positives and true positives for the different time-scales on a curve;
determining a best operating point using the curve; and
retrieving the time-scale used to construct the best operating point and setting the retrieved time-scale as the optimal time for the given rule.

17. The system of claim 15, wherein the determining of the optimal data volume using the distribution model for the historical orders data comprises:
finding a best model to fit a data volume distribution of the historical orders data labeled for the given rule;
estimating one or more parameters of the data volume distribution;
determining a data volume from the one or more parameters;
applying the data volume to test data with varying weights to calculate different data volumes;
plotting false positives and true positives for the different data volumes on a curve;
determining a best operating point using the curve; and
retrieving the data volume used to construct the best operating point and setting the retrieved data volume as the optimal data volume for the given rule.

18. The system of claim 15, wherein the method further comprises:
determining that the distribution model comprises a fat tail;
in response, creating a new rule and associating the optimal time and the optimal data volume with the new rule.

19. The system of claim 15, wherein the obtaining of the real-time orders data from the real-time order stream within the optimal time or the optimal data volume and the determining that at least one real-time orders data violates the given rule comprise:
obtaining the real-time orders data from the real-time order stream;
determining that the optimal time is met; and
in response, determining that at least one real-time order data obtained within the optimal time violates the given rule.

20. The system of claim 15, wherein the obtaining of the real-time orders data from the real-time order stream within the optimal time or the optimal data volume and the determining that at least one real-time orders data violates the given rule comprise:
obtaining the real-time orders data from the real-time order stream;
determining that the optimal data volume is met; and
in response, determining that at least one real-time order data within the optimal data volume violates the given rule.
